(19) United States
(12) Patent Application Publication
(10) Pub. No.: US 2003/0038849 A1
(43) Pub. Date: Feb. 27, 2003

(54) System and method for remotely interfacing with a plurality of electronic devices

(75) Inventors: Jeffrey Alan Craven, Cumming, GA (US); Marek Bugajski, Norcross, GA (US)

Correspondence Address: DORITY & MANNING, P.A., POST OFFICE BOX 1449, GREENVILLE, SC, 29602-1449, US

(73) Assignee: Nortel Networks Limited

(21) Appl. No.: 10/192,780

(22) Filed: Jul. 10, 2002

Related U.S. Application Data
(60) Provisional application No. 60/304,361, filed on Jul. 10, 2001.

(51) Int. Cl. G09G 5/00

(52) U.S. Cl. 345/864

(57) ABSTRACT

A method for interfacing a gateway with a plurality of electronic devices provided in a home networking environment includes establishing a communications link between the gateway and an intermediate device as well as providing input and output features at the intermediate device. A gateway in accordance with the disclosed technology may, for example, correspond to a cable modem, DSL interface, or other wireless home gateway that interfaces multiple data lines in a home networking environment. The remote intermediate device is outfitted with at least one wireless transmitter/receiver for communicating with a gateway and optionally with the networked electronic devices or appliances. Input features include a keypad with multiple user input buttons which may be actuated by a user's single hand when the remote device is held in the same single hand. Output features include a visual display such as an LCD matrix display. The visual display may be outfitted with touchscreen capabilities providing such output feature with an ability to dually function as an input feature. Additional functional components of the remote intermediate device include a processor and associated operating system, volatile and nonvolatile memory modules, an infrared transmitter/receiver, audio element, and smart battery with a recharging interface.

### PRIORITY CLAIM

This application claims priority to the benefit of previously filed U.S. Provisional Patent Application entitled “PERSONAL COMMUNICATION ASSISTANT”, filed on Jul. 10, 2001 and assigned U.S. S No. 60/304,361, which is incorporated herein for all purposes.

### FIELD OF THE INVENTION

The present invention generally relates to a wireless solution for remotely interfacing with a plurality of electronic devices, and more particularly to a non-infrared wireless solution that provides remote interfacing with specialized functionality for control of data communication devices in a home networking environment.

### BACKGROUND OF THE INVENTION

Modern residential and commercial locations are typically outfitted with a multitude of varied data communication services and electronic devices. For instance, many homes and offices today are provided with electronic technology for enabling voice data communication in accordance with telephony applications, audio and video communication for cable television applications and/or high speed data communication for internet applications. In the past, a consumer was typically forced to buy voice communication capabilities from one service provider, video communication capabilities from another service provider, and sometimes high-speed data capabilities from still another service provider. This separation in the marketplace of different communication service providers has typically stemmed from the provision of different cabling structures for each communication application. The maintenance of such distinct communication networks is often costly and inefficient, and thus undesirable for the service providers. Separate data services are also undesirable for the consumer since a customer must typically keep track of multiple bills, support numbers, etc.

With recent developments in the field of communications and electronic technologies, data communication providers have been able to offer multiple services from a single cabling source. A single network source (e.g., a hybrid fiber coax (HFC) network or FTTx-type optical fiber network) can now be utilized for connecting to the internet, receiving cable television service, relaying voice streams, and/or implementing other communication applications that employ digital signal configurations. These integrated services can be provided to end locations including a single dwelling unit (SDU), such as a home or office, and/or a multiple dwelling unit (MDU), such as an apartment-type housing development or an office complex.

Each end location in such an integrated service network is typically provided with one or more electronics devices that house various components for interfacing a consumer's selected services using the phones, TVs, computers, etc. inside a consumer's home or office. Such an electronics device typically corresponds to an indoor/outdoor, wall-mounted/desktop enclosure, such as a gateway that provides one or more lines of wired and/or wireless voice streams, audio/video streams, and/or high-speed data streams. Examples of a gateway may correspond to a high-speed cable modem, digital subscriber line (DSL) interface, or a wireless home gateway. A gateway or other similar device may obviate wiring clutter that may otherwise have been introduced to the interior living or working area of an end location.

Integrated data communication applications in a single network environment inherently incorporate a plurality of different electronic devices and appliances. These include not only gateway electronics, but also the plurality of devices such as televisions, phones, computers, etc. All such devices and appliances are typically necessary for a customer to interface with his/her selected communication services. Additional electronic devices may be employed in accordance with still further digital applications at an end location. The multitude of different electronic devices present at each end location in an integrated data services network presents a desire for a single device that can remotely access and control all such electronic devices.

Remote controls have conventionally been utilized to wirelessly interface with audio and video appliances, and may include a variety of features and functionality. For instance, “smart” remotes are available that can be programmed to control a multitude of different electronic devices at once. Some such smart remote controls even include features such as customized LCD displays, touch screen interfacing, and capability for programmable macro sequences that signal for multiple events to occur with the press of a single controller button. Providing a remote with a variety of functionality can be, however, quite challenging. Appropriate amounts of memory, battery power, and functionality must be designed and balanced for effective and efficient operation at a reasonable price. Yet even the most functional remote control has limitations. Conventional remote controls typically employ infrared signals to relay information wirelessly between the remote and the electronic appliance(s) it controls. Infrared signaling generally works only when a direct line of sight is available between wirelessly communicating devices. Even improved infrared signaling with which a clear signal path may not be required has definite limitations on the distances over which infrared signals can be transmitted or received. Thus, infrared remote controls may not be suitable for controlling a plurality of non-proximal electronic appliances within a given end location.

Other electronic devices besides remote controls have the ability to communicate over much longer distances. Electronic appliances such as cellular phones and personal computers (PCs) outfitted with wireless modems often have capabilities to wirelessly communicate within a global network. Personal digital assistants (PDAs) are characterized by functionality levels that are approaching those of a laptop/ portable computer. PDAs are typically characterized as relatively small and modular components, but have corresponding structures designed for use with two hands, similar to PC keyboards. Thus, conventional PDAs may not be suitable for single-handed control of other electronic devices within an end location.

Thus, a need exists for providing a remote device that includes aspects and features of conventional remote controls and PDAs while offering improved wireless communication capabilities and corresponding functionality. Such a remote device must be able to access and control a plurality of electronic devices and appliances within in a home networking environment.

### BRIEF SUMMARY OF THE INVENTION

Objects and advantages of the invention will be set forth in part in the following description, or may be obvious from the description, or may be learned through practice of the invention.

The present subject matter recognizes and addresses various drawbacks and other shortcomings related to remote control and wireless data communication interfacing between a gateway device and other electronics devices and appliances within a SDU or MDU end location. Thus, the presently disclosed technology is directed to an improved system and method for wireless data communication and interfacing with a plurality of electronic devices and appliances connected in a home networking environment.

More particularly, the subject system is capable of wirelessly communicating with one or more gateway devices that provide multiple lines of voice, audio/video, and/or data streams to other electronics devices or appliances. A gateway is generally connected via fixed line or wireless link to electronic devices that utilize the voice, audio/video, and data streams (i.e., telephone, television, computer, etc.). A remote device in accordance with the present subject matter can communicate with all these electronic devices or appliances either via an infrared communication link or via the wireless link through a gateway device.

Although having particular usefulness for communicating with a gateway device, such as a cable modem, and electronic devices or appliances to which a gateway is interfaced, it should be appreciated that the present invention is not limited to this use. Aspects of the invention may be used with other devices or in environments other than a particular home networking environment. Such uses may be known or become apparent to those skilled in the art and are within the spirit and scope of the invention. For illustrative purposes, embodiments of the disclosed technology according to the invention may be explained herein as they relate to a home networking environment. Aspects of the present subject matter concern providing a remote device for interfacing with electronic devices in a home networking environment, wherein the remote device is characterized by improved and versatile communication capabilities. Since a gateway that links a high-speed data network to home electronic devices or appliances can be situated at the exterior or at a hidden area of a dwelling unit, infrared signaling is not a generally effective wireless communications solution. Thus, a remote device in accordance with the present technology is outfitted with a non-infrared wireless transmitter/receiver that is capable of communicating over sufficient distances when there is not a clear path between devices. Examples of such RF communication links include those utilizing Bluetooth, IEEE 802.11 standards, UHF or Ultra Wide Band technologies.

A traditional infrared transmitter/receiver can be provided in addition to a non-infrared RF transmitter/receiver such that either communication link is available for devices or appliances including TVs, VCRs, DVD players, audio equipment, home security systems, etc., that are conventionally provided with infrared remote control capabilities. As other devices and applications become available relative to home networking, the potential functionality of a remote device in accordance with the present subject matter expands. The possibility for expanded device functionality as advances are made in home networking and related applications is within the spirit and scope of the present invention.

Several more specific aspects and advantages correspond to the remote device of the present invention, hereafter referred to as a personal communication assistant (PCA). A particular advantage of selected embodiments of the invention is improved cost efficiency for the functionality provided by a PCA. The amount of memory needed in the PCA is optimized since some information may simply be downloaded from the gateway or other remote location. Further, the PCA is generally characterized by low power consumption, reducing the necessary requirements for energy storage devices within the PCA.

Yet another advantageous aspect of embodiments of the present invention concerns the mechanical design of the subject PCA. PCA embodiments are provided with a modular design having a bottom portion contoured to be held by a single hand and configured such that input buttons can be actuated by a user's same single hand to support a gateway or electronic appliance. This design feature is often more desirable than many more bulky remote devices that require both hands of a user to operate all features of the device. The present technology also provides for a smart remote device that replaces multiple remote control devices that may previously have been utilized for controlling various electronic devices at a dwelling unit.

A still further advantageous aspect of embodiments of the disclosed technology corresponds to the inclusion of a visual display, such as an LCD matrix display as part of the remote device. This enables the PCA to act as a graphical user interface (GUI) separate from traditional GUI implementations that are provided only on conventional video displays. For example, it is often desirable for a user to be able to browse through an interactive programming guide and/or provisioning options available with cable service. To view this type of information, graphics typically overlay all or part of a television or other video display, yielding a cluttered viewing environment. A matrix display provided with the subject PCA enables one to browse programming guides, etc., at a separate location, thus facilitating non-intrusive viewing on a user's main video display (e.g., television).

Exemplary embodiments of the disclosed technology generally provide for a remote device with specialized RF communication features, and optional infrared communication features. Additional elements utilized in selected embodiments of the invention further include a visual display, such as a liquid crystal display (LCD) matrix display, which may have touch-screen capabilities so that the display can be used for providing output to a user as well as for receiving input from a user. Additional keypad button features can also be provided for receiving user input. An internal processor is connected to the various input, output, and communication features such that data can be manipulated as needed. The processor preferably includes the ability to load and unload Java applets from a remote location such that device operating system, services and functionality can be manually, automatically, and dynamically updated.

Additional features of the present technology that may be included in certain embodiments of the invention include volatile and non-volatile memory, such as flash memory, random-access memory (RAM), dynamic random-access memory (DRAM) and/or read-only memory (ROM). CPA embodiments may include a power input location for receiving a battery or other energy storage device, and also optional components for interfacing with a battery charger.

Other aspects and features of the present subject matter will become apparent to those of ordinary skill in the art upon review of the following description of specific embodiments of the invention in conjunction with the accompanying figures.

### BRIEF DESCRIPTION OF THE DRAWINGS

The above and other aspects, features, and advantages of the present subject matter will be more apparent from the following more particular description of particular embodiments of the invention as set forth in the appended figures, in which:

FIG. 1 illustrates an exemplary high-speed cable communication network in accordance with aspects of the present invention;

FIG. 2 illustrates exemplary electronic devices in a home networking environment that are controlled by a remote device in accordance with the present invention;

FIG. 3 provides a block diagram of components of a remote device in accordance with the present invention; and

FIG. 4 illustrates an exemplary embodiment of a remote device in accordance with the present invention.

Repeat use of reference characters throughout the present specification and appended drawings is intended to represent same or analogous features or elements of the presently disclosed technology.

### DETAILED DESCRIPTION

Reference will now be made in detail to embodiments of the invention, one or more examples of which are illustrated in the figures. The embodiments are provided by way of explanation of the invention, and not as a limitation of the invention. For example, features illustrated or described as part of one embodiment may be used with another embodiment to yield a still further embodiment. These and various other modifications and variations may be made to the embodiments set forth herein without departing from the spirit and scope of the invention.

As mentioned, embodiments of the invention are particularly useful in home networking environments and for interfacing with a gateway device, although the invention is not limited to such use. The invention may have application in any industry or environment wherein it is necessary or desirable to provide a single remote device to access and control a plurality of electronic devices. For purposes of explaining certain aspects of the invention, reference is made to embodiments of the invention particularly configured for use with a gateway device and home electronic devices to which the gateway is interfaced.

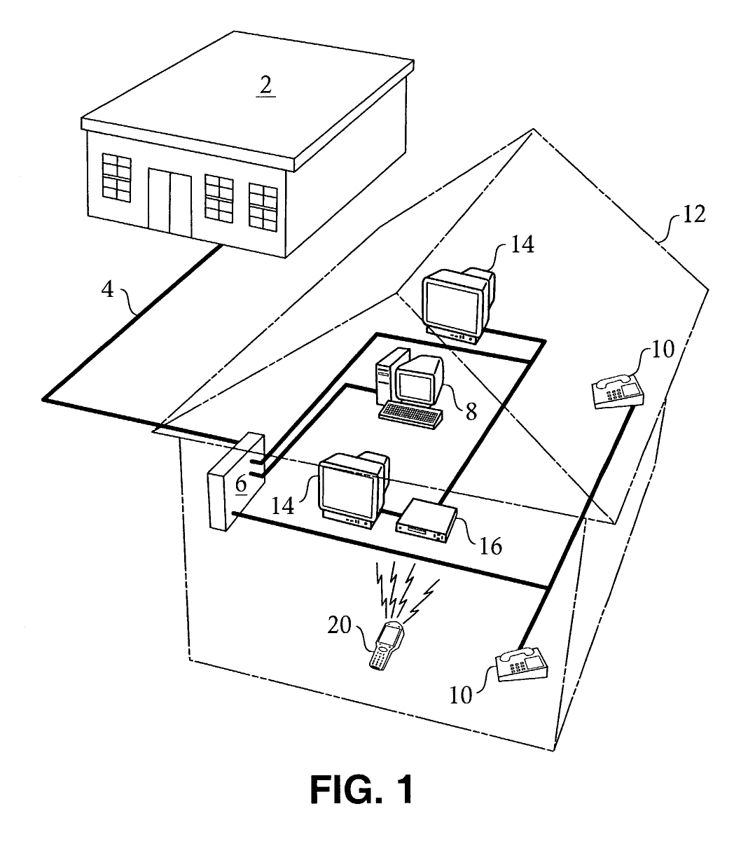

With reference to FIG. 1, a simple illustration is presented of a data communication network with high-speed data connections. A network service provider has a data communication distribution system 2 such as a Cable Modem Termination System (CMTS) for providing a connection into an access network 4. Access Networks 4 include but are not limited to copper cable coax, optical fiber, and/or wireless transmission links and connect data communication distribution system 2 with various end locations within the cable network. End locations could correspond to structures such as single dwelling units (SDUs), multiple dwelling units (MDUs), including residential, commercial or business structures.

An exemplary end location 12 as depicted in FIG. 1, is provided with a gateway device 6 that acts as an interface between the network and the various functional electronics devices within the structure, such as computer 8, phones 10, televisions 14, media player 16, etc. Examples of a gateway may correspond to a high-speed cable modem, digital subscriber line (DSL) interface, or a wireless home gateway. It should be appreciated that the present invention could be utilized with any specific type of modular interface point within a data network. Thus, the gateway 6 may comprise one or more video, voice, and data access point modules that provide respective voice, audio/video, and data signals from transmission medium 4 to applications such as digital cable, high-speed internet and IP telephony. Such features are well known and understood by those skilled in the art and a detailed explanation thereof is not necessary for an understanding of the invention.

In accordance with the present invention, a remote device 20, referred to for convenience as a personal communication assistant (PCA), is provided for controlling the various electronic devices and appliances in a home networking environment. A wireless access point may be included with gateway 6 for remotely communicating with the PCA 20.

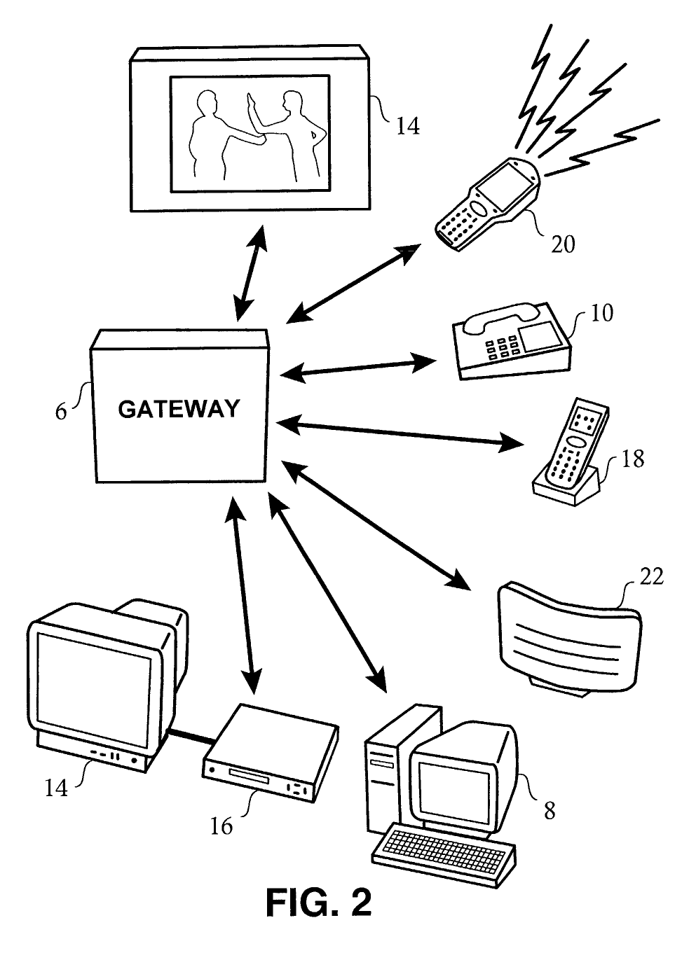

FIG. 2 provides an illustration of the different types of electronic devices or appliances with which a remote device 20 in accordance with the present technology may interface. Since a gateway is typically connected to a majority of the electronic devices in a home networking environment, such as televisions 14, telephones 10, and computers 8, remote device 20 may preferably communicate directly with gateway 6, which may then in turn relay signals to respective electronic devices associated with gateway 6. In addition to the previously disclosed exemplary devices in a home networking environment, other devices or appliances may include a camera, a stereo, a jukebox, a home security device, a home telemetry device, or other home appliances.

It should be noted that each electronic device provided in the home networking environment communicates with gateway 6 via either a wired or wireless link. For instance, consider such a communication link for a digital television service. PCA 20 can receive signals relating to the display of a digital TV channel guide and for setting up a personalized graphical user interface (GUI) for a corresponding TV program guide and access control thereof. In addition, PCA 20 can transmit information regarding channel selection, pay-per-view purchases, and various navigation commands. PCA 20 can also be utilized to set up security and parental access control for a television or other devices in a home network.

With further reference to FIG. 2, other devices may or may not be part of the home networking environment controlled by gateway 6. Thus, it is preferred that PCA 20 is also capable of directly communicating with selected of the electronic devices, which further include cellular phones 18, and home access controllers 22. Although not specifically shown in the exemplary embodiment of FIG. 2, it should be appreciated that additional systems and devices may also be included in the remote control and communication of the present invention. Examples include security systems, garage door openers, home heating control, ceiling fans, kitchen appliances such as stoves and refrigerators, and others as interfacing capabilities become more prevalent.

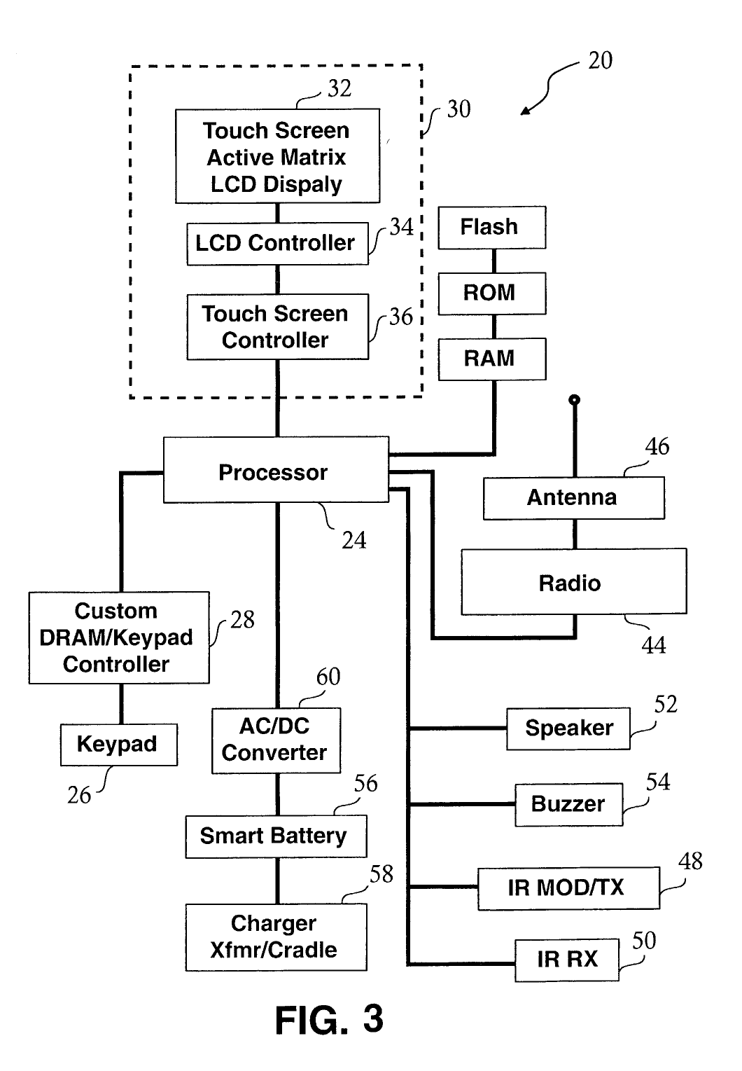

FIG. 3 provides a block diagram of the functional components of an exemplary PCA in accordance with the present invention. It should be appreciated that some or all of the components illustrated in FIG. 3 may be used to form further alternative embodiments of the invention. The PCA circuitry includes processing means 24, which is electrically connected to many of the other components of PCA 20. Processor 24 is able to manipulate data as necessary to relay among the various components in PCA 20, and is preferably able to process aspects of the RF signals communicated among PCA 20 and the gateway 6 or other electronic device(s). The processor may also be able to handle Java, which is associated with an exemplary Java-based operating system that may be provided with PCA software. Specific features of processor 24 may be designed for different aspects of processor operation while still falling within the spirit and scope of the present invention. It should be well within the purview of one of ordinary skill in the art to configure and design such processor aspects, and thus additional processor description need not be provided herein.

The exemplary Java operating system and software of processor 24 in PCA 20 can provide the ability to discover and automatically download applets for other devices that are introduced in the home networking environment. A full-featured standards-based communication stack such as TCP/UDP-IP may be employed with the operating system of the present invention. PCA 20 may also be provided with the ability to manually, automatically and dynamically update its operating system, patches, applets, etc. through the gateway or through the internet. Software may also provide for automated testing and alerting for wireless link status, low battery power, low memory, and other desired indications. Software may include web browsing programs such that PCA 20 can support HTML, WML, Java and/or XML applications. PCA 20 may also include encryption capabilities for providing a secure data transfer option for applications such as E-commerce.

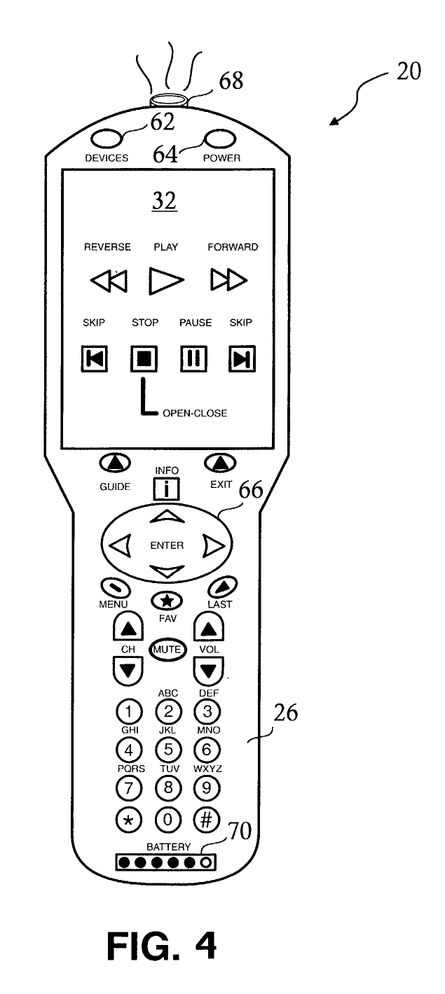

Actuation means may be included in PCA 20 such that a user can provide input to the PCA indicative of functions to be performed by selected of the electronic devices in a home networking environment. Actuation means may correspond to keypad, in which case a keypad controller 28 with customized dynamic random-access memory (DRAM) may be provided. An example of a specific keypad design will be presented with respect to FIG. 4. User input may alternatively be provided by voice control as opposed to manual actuation of buttons on a keypad.

Display means may also be provided with the exemplary PCA 20 of FIG. 3 to provide a user with visible information corresponding to the status or functionality or various electronic devices within the network environment. Display means 30 may include an LCD matrix display, to which an LCD controller 34 is connected. LCD matrix display 32 may be a variety of sizes, for example six-by-eight cm, could display information in either single of multiple colors, and may be an active matrix in certain embodiments. Display means could be outfitted with a rich color Back-lit display for improved viewing in poorly-lit areas, as well as with an anti-glare screen. LCD matrix display 32 may also be outfitted with touch screen capabilities such that display means can further serve to receive input from a user. A touch screen controller module 36 is provided when LCD matrix display 32 has touch screen capabilities. Display means 30 may alternatively be provided with organic light emitting device (OLED) technology as opposed to LCD technology.

Storage means is also preferably provided in accordance with the exemplary PCA embodiment 20 of FIG. 3, and may include both volatile and non-volatile memory to store certain information inputted to PCA 20 by the user as well as information communicated to and from interfaced electronic devices. Such memory may also be utilized for the multitude of programming functionality available with PCA 20. Memory modules may specifically comprise selected of flash memory 38, read-only-memory (ROM) 40, and random-access-memory (RAM) 42. At least six Mega-bytes (MB) of RAM memory are provided in certain embodiments of the present technology. The amount of memory needed in PCA 20 may be less than in other remote devices since select information can be downloaded from an electronic device as opposed to being stored within onboard memory. An example of selectively stored information corresponds to storing the IR control codes for the most popular conventional electronic appliances, including televisions and media players (such as VCR, DVD, TIVO, etc.), while downloading the codes for less popular appliances from the service provider or from the equipment vendor's website.

PCA 20 includes at least one type of RF communication link 44 capable of relaying signals sufficient distances with or without a clear line-of-sight signal path. An example of such a communication link corresponds to a Bluetooth Class 1 RF Radio, including transmitter and receiver for relaying signals in accordance with Bluetooth technology standards. Other communication protocols may correspond to IEEE 802.11 standards, UHF or Ultra Wide Band technology. RF communication link 44 can be provided with an antenna 46 either internal or external to PCA 20 for radiating and receiving the RF (e.g., Bluetooth) signals. In certain embodiments of the technology the RF radio and antenna are capable of transmitting at least fifty to one-hundred meters. The configuration of an RF transmitter/receiver with technology corresponding to any of the above communication protocols or other protocols can be designed to operate in accordance with numerous different functional criteria. Such design of specific aspects of an RF link should be understood by one of ordinary skill in the art and is thus need not be described in additional detail herein.

PCA 20 may also include components that provide for infrared (IR) communication, such as IR modulator and transmitter component 48 and IR receiver component 50. An IR transmitter/receiver provides a capability to communicate with existing electronic devices when a user has a relatively clear signal path between such devices and the PCA. The IR communication elements further provide an ability to download IR codes from a peripheral electronic device. Audio output elements may also be provided with PCA 20, for example a speaker 52 and/or a buzzer 54. Buzzer 54 can be used in conjunction with IR communication features to help locate PCA 20 by actuating a button at a given electronic device (e.g., television) that produces an audio signal at the PCA 20.

Power is preferably provided to the various components of PCA 20 via a chargeable energy storage device, such as a battery or super capacitor. An example of an energy storage device is a smart battery 56 (such as a rechargeable lithium ion battery.) Such energy storage device may be recharged by connection to a battery charger or transformer, such as could be provided in a recharge cradle 58. An AC/DC converter 60 may also be included in PCA 20 to provide the required energy levels from smart battery 56 to processor 24 and other components of PCA 20. Low power consumption may be facilitated by providing the PCA with an ability to have certain components (such as the display) exist in a “sleep mode” when PCA 20 is idle. In some embodiments, battery 56 may be used in normal operating conditions for up to seven or more days before needing to be recharged.

The various components illustrated in FIG. 3 have been described above with respect to specific exemplary aspects of the subject device interfacing technology. However, the general capabilities of each functional component illustrated in FIG. 3, including the processor, converter, battery, charger, keypad, visual display, various memory modules, controllers, and wireless transmitter/receivers are well known to those skilled in the art, and thus it should be within the spirit and scope of the present invention to modify specific aspects of each such functional component to comply with varied design criteria. For such reasons, additionally specified details concerning each functional component need not be presented herein.

Further, the layout and connections among components presented in FIG. 3 is by way of example, not limitation of the invention. The internal circuitry and organized arrangement of the functional components presented herein and other components as fall within the spirit and scope of the invention can be configured in a variety of fashions. Electrical connection among the included components can vary depending on specific design criteria, and such modifications should be within the purview of one of ordinary skill in the art. For such reasons, additional details concerning the arrangement and connecting links among the functional components of the subject remote device need not be presented herein.

An exterior view of an exemplary remote PCA 20 in accordance with the present invention is illustrated in FIG. 4. The remote 20 is preferably hardily constructed with a robust material such that the device can withstand common accidents such as being dropped on hard surfaces from several feet above the ground. The bottom portion of the device (generally corresponding to the location of keypad 26) is designed with a contour such that it can be held with a user's single hand while buttons on keypad 26 can simultaneously be actuated. An exemplary overall size of PCA 20 corresponds to a 7×22×6 cm shell.

Keypad 26 is characterized by a plurality of user input buttons, which may be included and/or combined in a variety of fashions in accordance with the present subject matter. The user input buttons may illuminate in certain embodiments to indicate use of PCA 20 with different electronic devices. A “DEVICES” button 62 enables a user to select between different electronic devices. For each different device selected, user input buttons can serve differing functions and matrix display 32 can provide information directed to each device. A “POWER” button 64 can be used to power on/off the PCA itself or to power on/off different selected electronic devices in the home network environment. User input buttons are provided on keypad 26 corresponding to each digit 0-9, respectively, as well as function keys represented by “*” and “#.” The respective digit keys may also be utilized to enter alphanumeric information, specifically corresponding to each letter in the alphabet. Two “VOL” buttons may be provided to adjust the volume level of the PCA or of a selected device up and down, respectively. Two “CH” buttons can be included to change cable channels or selections on a media device (such as DVD/CD track number) in a forward or reverse direction. A “MUTE” button may be provided to adjust the volume level of the PCA or other electronic device to a completely on or off state. Selected of the two “VOL” buttons and the “MUTE” button may collectively be referred to as volume actuation buttons. A “LAST” button may be provided such that a user can return to the channel or track selection most previously viewed or listened to. A “FAV” button can be available for selecting a user's favorite television channel or favorite music station, etc.

Additional input buttons, including “GUIDE”, “EXIT”, “INFO”, and “MENU” may be provided for actuated use with an interactive program guide or other GUI provided on matrix display 32 or on another video display. Generally circular keypad portion 66 may include a plurality of scrolling buttons, also for interacting with GUI applications and interactive programming among other things.

With further reference to the exemplary PCA embodiment of FIG. 4, PCA 20 may also include an optical port 68 through which infrared signaling can be effected. Further, an indicator strip 70 may be provided to alert the user to the current amount of battery power available to the PCA before the device needs to be recharged. A wireless signal power level indicator may also be incorporated into a PCA embodiment in accordance with the present invention.

Matrix display 32 can provide output indicating the status and other aspects of a plurality of different electronic devices, including telephone, television and computer. A specific ability of matrix display is to provide an interactive viewing and provisioning guide for services that can be viewed without obstructing the display area of a television or other video device. Specific display features for an interactive cable program guide may include program name, description, and start/stop time for each channel and corresponding current program provided with the cable service. An interactive channel guide provided in accordance with PCA 20 may provide nested menus with upcoming content information, personalized channel guide preference settings, and either touchscreen controls or keypad commands. Such interactive guide can perform searches based on user-selected criteria, including genre, ratings, actor/actress, and specific content language. Upcoming program reminders and automatic tuning management and control services can be provided in accordance with the interactive channel guide. Such automatic tuning could be specifically utilized as a babysitter service whereby transition from show to show is pre-programmed to automatically switch

Matrix display 32 may also provide the ability to display and manage communication services within a home networking environment. PCA 20 can thus provide messaging display, control, and archival of incoming caller ID notification, including such information as the time of day, caller name and telephone number corresponding to each incoming and outgoing phone call. PCA 20 can also provide messaging display, control and archival of e-mail messages and new e-mail notification, including such information as time sent, originator, and subject line. Matrix display 32 in conjunction with an audio speaker output can provide audio and visual display, control and archival of voice-mail or other messaging service. Any of the information displayed on matrix display 32 may also be viewed on an interfaced television or other video display.

Additional functionality may be provided by the PCA system and remote device of the present invention. PCA 20 may be used for provisioning-management and control of other electronic devices in the home networking environment. For example, telephone usage in a particular bedroom can be regulated via parental control. Similar regulations can be implemented for television profile management and control, which is often based on available data from a service provider such as genre, ratings, actor/actress, and specific language content. Specific messaging and data services may be provided for interactive content retrieval and display such as viewing real-time statistics during sporting events or a stock ticker for financial shows, display and/or storage of recipes for cooking shows, recapture provision of previously shown TV episodes, and even real-time ordering services including shopping, pizza, etc. A PCA may also be utilized to do video clip playbacks.

Still further functionality offered by a PCA includes an ability to communicate with a personal computer and/or specific websites. In accordance with such computer interaction, applets can be downloaded to personalize a PCA configuration. Websites for advertisers, providers of E-commerce, and others can be bookmarked. The PCA also may include the ability to be programmed remotely via the internet or cellular phone. PCAs may be utilized in accordance with interactive gaming such as trivia shows or user polls, while providing an ability to display information such as gaming scores, rank, etc. Interactive help guides and updating tools may be provided such that the PCA can interact with the gateway. For instance, different service packages can be ordered and updated via the PCA. User self-subscription to a plurality of web-based services is also feasible.

PCAs may be provided with a short messaging service such that instant messaging can occur among different PCAs (for example, multiple PCAs in an apartment complex or other multiple dwelling unit.) Instant messaging may be effected to/from the PCA to video modules within a home to provide information such as phone numbers where a user can be reached by a babysitter. Current and archived viewed programs can be monitored to determine what other users have been viewing or selecting within a home network. As technology advances, it is understood that the software and operating system of a PCA can be expanded to incorporate additional functionality, while still falling within the spirit and scope of the present invention.

While the invention herein disclosed has been described by means of specific embodiments, numerous modifications and variations could be made thereto by those skilled in the art without departing from the scope of the invention set forth in the claims. Accordingly, the scope of the present subject matter should be assessed as that of the disclosed variation of embodiments and any equivalents thereto.

What is claimed is:

1. A remote communication device for wirelessly interfacing with a gateway, said remote communication device comprising:
a visual display;
a plurality of user input buttons, wherein selected of said user input buttons are utilized to actuate multiple distinct functions;
an RF transmitter/receiver for wirelessly communicating with a gateway;
a processor electrically connected to said LCD matrix display, said user input buttons, and to said RF transmitter/receiver; and
memory connected to said processor.

2. A remote communication device as in claim 1, wherein said remote communication device is a handheld device.

3. A remote communication device as in claim 1, wherein said visual display is an LCD matrix display.

4. A remote communication device as in claim 1, wherein said visual display includes touch screen technology such that a user can input information to said remote communication device via contact with said matrix display.

5. A remote communication device as in claim 4, wherein said visual display is an LCD matrix display.

6. A remote communication device as in claim 1, wherein said plurality of user input buttons comprise a power button, a menu button, a devices button, buttons corresponding to each digit 0-9 respectively, volume actuation buttons, and at least two scrolling buttons.

7. A remote communication device as in claim 1, wherein said RF transmitter/receiver is capable of wirelessly and remotely transmitting and receiving signals over ranges of at least fifty meters and with or without a clear line of sight between communicating devices.

8. A remote communications device as in claim 7, wherein said RF transmitter/receiver communicates in accordance with Bluetooth technology standards.

9. A remote communications device as in claim 1, wherein said processor provides the capability to automatically and dynamically load and unload applications from a remote location.

10. A remote communications device as in claim 1, wherein said memory comprises both volatile and non-volatile memory.

11. A remote communications device as in claim 10, wherein said memory includes flash memory, read-only memory (ROM) and random-access memory (RAM).

12. A remote communications device as in claim 1, wherein the gateway with which said remote communication device communicates provides at least one respective voice, data, and video datastream to a plurality of electronic devices within an end location.

13. A remote communication device as in claim 1, further comprising an infrared transmitter/receiver electrically connected to said processor for providing a remote signal directly to an electronic device.

14. A personal communication device for remotely accessing and controlling a plurality of electronic devices provided at a single or multiple dwelling unit, said personal communication device comprising:
an LCD matrix display with touch-screen interfacing capabilities;
a keypad with a plurality of user input buttons;
a processor electrically connected to said keypad such that information inputted by a user can be processed and further electrically connected to said LCD matrix display such that output and input can be processed;
a wireless transmitter/receiver electrically connected to said processor for providing a remote signal to selected of the plurality of electronic devices provided at the single or multiple dwelling unit;
an infrared transmitter/receiver electrically connected to said processor for providing a remote signal to selected of the plurality of electronic devices provided at the single or multiple dwelling unit;
memory connected to said processor; and
a power input location for interfacing with an energy storage device.

15. A personal communication device as in claim 14, wherein said LCD matrix display with touchscreen capabilities provides an additional plurality of user input buttons to effect selected actions at selected electronic devices provided at the single or multiple dwelling unit.

16. A personal communication device as in claim 14, wherein said plurality of user input buttons comprise but not limited to a power button, a menu button, a devices button, buttons corresponding to each digit 0-9 respectively, volume actuation buttons, and at least two scrolling buttons.

17. A personal communication device as in claim 14, wherein said wireless transmitter/receiver is capable of remotely transmitting and receiving signals over ranges of at least fifty meters and with or without a clear line of sight between communicating devices.

18. A personal communication device as in claim 17, wherein said wireless transmitter/receiver communicates in accordance with Bluetooth technology standards.

19. A personal communication device as in claim 17, further comprising an antenna for radiating and receiving the remote wireless signals transmitted and received by said wireless transmitter and receiver.

20. A personal communication device as in claim 14, wherein said processor provides the capability to load and unload applications from a remote location.

21. A personal communication device as in claim 14, wherein said memory comprises both volatile and non-volatile memory.

22. A personal communication device as in claim 21, wherein said volatile and non-volatile memory comprises flash memory, read-only memory (ROM) and random-access memory (RAM).

23. A personal communication device as in claim 14, wherein the plurality of electronic devices provided at a multiple or single dwelling unit include at least one device selected from the group consisting of a television, a telephone, a camera, a stereo, a jukebox, a home security device, a home telemetry device, a home appliance and a computer.

24. A personal communication device as in claim 14, wherein said personal communication device is designed to be held by a user's single hand and such that each of the plurality of user input buttons are readily accessible by a user when held by a single hand.

25. A personal communication device as in claim 14, further comprising at least one audio output element.

26. A personal communication device as in claim 25, wherein said at least one audio output element comprises a speaker.

27. A personal communication device as in claim 14, further comprising an AC/DC converter and a smart battery configured to interface with a battery charger.

28. A remote system for controlling a plurality of electronic devices connected in a home networking environment, wherein said plurality of electronic devices includes a television and wherein said remote system comprises:
non-infrared communication means for wirelessly transmitting and receiving signals from selected of the plurality of electronic devices;
actuation means for inputting user-selected information indicative of functions to be performed by selected of the plurality of electronic devices;
display means for providing a user with visible information corresponding to status and functionality of selected of the electronic devices; and
processing means for manipulating information inputted to said remote system via said non-infrared communication means and via said actuation means as well as information outputted by said remote system to said display means.

29. A remote system for controlling a plurality of electronic devices connected in a home networking environment as in claim 28, wherein said remote system provides an interactive program guide with content information indicative of program listings for different television channels.

30. A remote system for controlling a plurality of electronic devices connected in a home networking environment as in claim 28, wherein said non-infrared communication means comprises a Bluetooth transmitter/receiver capable of wirelessly communicating signals over a range of at least fifty meters.

31. A remote system for controlling a plurality of electronic devices connected in a home networking environment as in claim 28, wherein said actuation means comprises a keypad with a plurality of buttons accessible by a user's single hand as the remote system is held by user's same single band.

32. A remote system for controlling a plurality of electronic devices connected in a home networking environment as in claim 28, wherein said display means comprises an LCD matrix display with touchscreen functionality.

33. A remote system for controlling a plurality of electronic devices connected in a home networking environment as in claim 32, wherein said display means further provides an additional actuation means for inputting user-selected information indicative of functions to be performed by selected of the plurality of electronic devices.

34. A remote system for controlling a plurality of electronic devices connected in a home networking environment as in claim 28, further comprising memory means for storing select information inputted by a user.

35. A remote system for controlling a plurality of electronic devices as in claim 34, wherein said memory means comprises flash memory and random-access memory (RAM).

36. A method for interfacing a gateway with a plurality of electronic devices provided in a home networking environment, wherein a wired or wireless link between selected electronic devices and said gateway is provided, said method comprising the steps of:
establishing an RF link between said gateway and an intermediate device, wherein said RF link is capable of relaying signals without having a direct line of sight between the gateway and the intermediate device;
providing means for a user to provide input to the intermediate device, such user input capable of being processed and transmitted over the established RF link; and
providing means for a user to view output at the intermediate device, wherein selected output is received by the intermediate device from the gateway.

37. A method for interfacing a gateway with a plurality of electronic devices as in claim 36, wherein the established RF link comprises a non-infrared wireless link characterized by a minimum signal relay distance of fifty meters.

38. A method for interfacing a gateway with a plurality of electronic devices as in claim 36, wherein signals transmitted and received over the established RF link are configured according to Bluetooth technology standards.

39. A method for interfacing a gateway with a plurality of electronic devices as in claim 36, wherein the means for a user to provide input to the intermediate device comprises a keypad with a plurality of user input buttons.

40. A method for interfacing a gateway with a plurality of electronic devices as in claim 36, wherein the means for a user to view output at the intermediate device comprises an LCD matrix display.

41. A method for interfacing a gateway with a plurality of electronic devices as in claim 40, wherein the LCD matrix display includes touchscreen capabilities such that the display also serves as a means for a user to provide input to the intermediate device.
